(19) United States
(12) Patent Application Publication
(10) Pub. No.: US 2025/0000221 A1
(43) Pub. Date: Jan. 2, 2025

(54) Fisherman's Cane Pole Device

(71) Applicant: Ronald Overly, Prescott Valley, AZ (US)

(72) Inventor: Ronald Overly, Prescott Valley, AZ (US)

(21) Appl. No.: 18/474,913

(22) Filed: Sep. 26, 2023

Related U.S. Application Data
(60) Provisional application No. 63/510,447, filed on Jun. 27, 2023.

(51) Int. Cl. A45B 3/00; A01K 87/02

(52) U.S. Cl. CPC A45B 3/00; A01K 87/025; A45B 2009/007; A45B 2200/05

(57) ABSTRACT

A fishing pole walking cane combination device is disclosed that is a dual purpose rod that can be used as both a walking cane and a fishing pole. The fishing pole walking cane combination device comprises a body component that is configured in a plurality of telescopic segments, that when collapsed, it is a walking cane and when extended, it will function as a fishing pole. The distal end of the body component comprises a curved cane handle and the proximal end of the body component comprises a rubber tip that can be taken off to allow the fishing pole to be extended. The body component also comprises a place for a reel to be secured and easily detached.

### CROSS-REFERENCE TO RELATED APPLICATION

The present application claims priority to, and the benefit of, U.S. Provisional Application No. 63/510,447, which was filed on Jun. 27, 2023, and is incorporated herein by reference in its entirety.

### FIELD OF THE INVENTION

The present invention relates generally to the field of fishing pole walking cane combination devices. More specifically, the present invention relates to a multifunctional, telescopic rod that doubles as a walking cane and fishing pole. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in fishing pole walking cane combination devices. Generally, elderly individuals or those with physical limitations may be unable to walk without a cane. Further, trying to carry fishing equipment to and from a fishing spot while also using a cane may be difficult, especially when alone. Additionally, carrying equipment with only one hand may be nearly impossible, and people may risk damage to their fishing rods, reels, and tackle if they are accidentally dropped.

Further, instead of having to juggle both a walking cane and a fishing pole, it would be advantageous to provide an implement which may be metamorphosed from a walking cane into a fishing rod, or vice versa. Accordingly, the shank of the walking cane would contain telescopic elements which are extensible in length when the device is used as a fishing rod.

Accordingly, there is a demand for an improved fishing pole walking cane combination device that prevents users from having to carry both a fishing rod and a walking cane. More particularly, there is a demand for a fishing pole walking cane combination device that has expanding and retracting components, which enable users to selectively collapse the device into a walking cane and expand it into a fishing rod.

Therefore, there exists a long felt need in the art for a fishing pole walking cane combination device that provides users with a multifunctional, telescopic rod that doubles as a walking cane and fishing pole. There is also a long felt need in the art for a fishing pole walking cane combination device that allows handicapped and physically limited people to enjoy fishing while still being able to walk to and from their fishing spot with ease. Further, there is a long felt need in the art for a fishing pole walking cane combination device that prevents users from having to carry a fishing rod and fishing accessories with only one hand due to operating a standard walking cane in the other. Moreover, there is a long felt need in the art for a device that features expanding and retracting components, enabling users to selectively collapse the device into a cane and expand it into a fishing rod and reel. Further, there is a long felt need in the art for a fishing pole walking cane combination device that offers a way for any physically limited individual to enjoy fishing. Finally, there is a long felt need in the art for a fishing pole walking cane combination device that comprises a rubber tip which is removed to allow the fishing pole to be extended.

The subject matter disclosed and claimed herein, in one embodiment thereof, comprises a fishing pole walking cane combination device. The device is a dual purpose rod that can be used as both a walking cane and a fishing pole. The fishing pole walking cane combination device comprises a body component that is configured in a plurality of telescopic segments, that when collapsed, it is a walking cane and when extended, it will function as a fishing pole. The distal end of the body component comprises a curved cane handle and the proximal end of the body component comprises a rubber tip that can be taken off to allow the fishing pole to be extended. When extended, the body component measures approximately between six and seven feet long. The body component also comprises a place for a reel to be secured and easily detached. Users can convert the body component to a fishing pole or walking cane and vice-versa, making it much easier for physically limited individuals to travel to and from their favorite fishing locations with fishing equipment.

In this manner, the fishing pole walking cane combination device of the present invention accomplishes all of the forgoing objectives and provides users with a device that doubles as a walking cane and fishing pole. The device prevents users from having to carry a fishing rod with one hand and a walking cane in the other. The device offers a way for any physically limited individual to enjoy fishing.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fishing pole walking cane combination device. The device is a dual-purpose rod that can be used as both a walking cane and a fishing pole. The fishing pole walking cane combination device comprises a body component that is configured in a plurality of telescopic segments, that when collapsed, it is a walking cane and when extended, it will function as a fishing pole. The proximal end of the body component comprises a curved cane handle and the distal end of the body component comprises a rubber tip that can be taken off to allow the fishing pole to be extended. When extended, the body component measures approximately between six and seven feet long. The body component also comprises a place for a fishing reel to be secured and easily detached. Users can convert the body component to a fishing pole or walking cane and vice-versa, making it much easier for physically limited individuals to travel to and from their favorite fishing locations with fishing equipment.

In one embodiment, the fishing pole walking cane combination device comprises a body component that is configured in a plurality of telescopic segments, that when collapsed, it is a walking cane and when extended, it will function as a fishing pole. Specifically, the body component is configured in a cylindrical rod-like structure and configured into a single piece or multiple sections that telescope together. If multiple telescoping sections are used, the length of the body component can be modified via a telescopic mechanism. Further, the body component comprises at least one telescoping segment that allows the total length of the body component to be extended or retracted. Each telescoping segment is hollow and has a slip lock for locking the segment at a specific length. Further, the slip lock is released by means of pressing or turning the slip lock. The at least one telescoping segment allows the body component to have a length from approximately three feet to seven feet fully extended, allowing a user to set the device at a desired height. Thus, the device is approximately three feet in length but can be adjusted to a length of approximately seven feet, if needed. Any type of telescoping locks, such as a clutch lock, cam lock, spring button, snap lock, set knob or any other suitable lock as is known in the art, can be used for securing a desired length of the telescoping segments and for securing the telescoping segments to each other, during extension and retraction of the telescoping segments of the body component.

In one embodiment, the distal end of the body component comprises a rubber tip or stopper that can be taken off to allow the fishing pole to be extended. Specifically, the distal end of the body component comprises the tip of the fishing pole, when extended. The tip of the fishing pole is then covered with a rubber tip or stopper, to allow the device to be used as a walking cane.

In one embodiment, the proximal end of the body component comprises a handle component. Specifically, the handle component extends outward from the opposing proximal end of the body component and may be secured to the proximal end via any suitable securing means as is known in the art, such as heat-staked, adhesives, pinned, couplings, screws, snap fit, etc. In one embodiment, the body component and the handle component may be formed as a single, solid plastic assembly. The handle component can be any suitable shape and size as is known in the art. Further, the length and diameter of the handle component may vary widely, as it is important only that it be reasonably comfortable to hold in a user's hand with relative ease.

In one embodiment, the handle component can also be curved or rounded, or otherwise ergonomically shaped to allow the user to more easily use the device as a walking canc. Specifically, the handle component can be configured in a curved cane handle, a bent handle, or a straight handle with a rubber knob end, etc., or any other suitable shape as is known in the art, depending on the wants and/or needs of a user. Further, the handle component comprises a rubber coating or other soft coating that provides gripping and texture for the user, during use.

In one embodiment, the handle component comprises a textured cross section or gripping area, or any other suitable ergonomic grip, texture, coating, etc., as is known in the art, depending on the needs and/or wants of a user.

In another embodiment, the handle component may also be provided with an elongated hole with a string or rope attached, to allow the device to be hung from a hook on a door or wall.

In another embodiment, the body component comprises a fishing reel secured thereto. Typically, the fishing reel is secured to an inner section near the handle component at the proximal end, in any suitable manner as is known in the art, such as by a hook and a clamp device, screws, bolts, etc. The fishing reels secured to the body component are generally, a casing reel, a spinning reel, or a fly reel, however any other suitable fishing reel can be secured to the body component as is known in the art, depending on the needs and/or wants of a user.

In one embodiment, once the fishing reel is attached to the body component, fishing line is then threaded from the fishing reel down the body component via a plurality of eyelets, eyes, or tightly threaded rings and secured. In one embodiment, the device can also comprise a plurality of rubber tip covers for closing or capping the plurality of eyelets during transport, to protect the fishing line.

In one embodiment, the body component also comprises a rubber gripping component or rubber coating that is applied around the circumference of the body component, past the handle component and the fishing reel. The rubber gripping component acts as a suitable ergonomic grip, texture, or coating for the body component, when the user is using the fishing pole. Thus, when the body component is configured as a fishing pole, the user can use the rubber gripping component as a handle, while casting and fishing with the device.

In one embodiment, the body component comprises at least one compartment for storing fishing accessories, such as fishing hooks, lures, bobbers, etc. The at least one compartment would typically have a hinged lid for securing the contents within.

In one embodiment, to collapse the device, the slip locks are disengaged from the telescoping segments and the sections telescoped together. The user then winds up the fishing line within the fishing reel, as the fishing pole is collapsed. After collapsing, the fishing reel may be removed, as needed or locked into place for transport. A rubber stopper or tip is applied to the distal end of the body component to cover and protect the tip of the fishing pole, as well as to provide traction when using the walking cane. A user can then grasp the handle component and utilize the device as a walking cane to walk to their favorite fishing spot.

In one embodiment, to expand the device, the telescoping segments are expanded to a desired height and slip locks are engaged, securing the telescoping segments at a desired length. Once secure, the user then releases the fishing line from the fishing reel and threads it through the plurality of eyelets to be secured at the distal end. The rubber cap is then removed from the distal end, exposing the fishing pole tip. The user can then grasp the rubber gripping component as a handle to cast and fish with the fishing pole device.

In one embodiment, the fishing pole walking cane combination device is made of a lightweight, durable material such as plastic, fiberglass, carbon fiber, or the like and manufactured through common extruding and molding processes. Generally, the fishing pole walking cane combination device is also manufactured from a material that is water resistant or waterproof, or the body component comprises a coating that is water resistant or waterproof. Furthermore, the fishing pole walking cane combination device can be molded in various colors and patterns to be aesthetically pleasing, based on the wants and/or needs of a user.

In yet another embodiment, the fishing pole walking cane combination device comprises a plurality of indicia.

In yet another embodiment, a method of converting a walking cane into a fishing pole is disclosed. The method includes the steps of providing a fishing pole walking cane combination device comprising a body component configured in a plurality of telescoping segments, with a curved cane handle at the proximal end and a removable rubber tip at the distal end. The method also comprises collapsing the telescoping segments into the walking cane configuration and replacing the rubber tip. Further, the method comprises utilizing the walking cane to walk to a fishing spot. The method also comprises removing the rubber tip and expanding the telescoping segments into the fishing pole configuration. Finally, the method comprises utilizing the fishing pole to fish.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the fishing pole walking cane combination device of the present invention showing the device extended as a fishing pole in accordance with the disclosed architecture;

FIG. 2 illustrates a perspective view of one embodiment of the fishing pole walking cane combination device of the present invention showing the device collapsed into a walking cane in accordance with the disclosed architecture;

FIGS. 3A-B illustrate a perspective view of one embodiment of the fishing pole walking cane combination device of the present invention showing the device expanded as a fishing pole and collapsed into a walking cane for use in accordance with the disclosed architecture;

FIGS. 4A-C illustrate a side perspective view of one embodiment of the fishing pole walking cane combination device of the present invention showing the different reels attached to the fishing poles in accordance with the disclosed architecture; and

FIG. 5 illustrates a flowchart showing the method of converting a walking cane into a fishing pole in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a fishing pole walking cane combination device that provides users with a multifunctional, telescopic rod that doubles as a walking cane and fishing pole. There is also a long felt need in the art for a fishing pole walking cane combination device that allows handicapped and physically limited people to enjoy fishing while still being able to walk to and from their fishing spot with ease. Further, there is a long felt need in the art for a fishing pole walking cane combination device that prevents users from having to carry a fishing rod and fishing accessories with only one hand due to operating a standard walking cane in the other. Moreover, there is a long felt need in the art for a device that features expanding and retracting components, enabling users to selectively collapse the device into a cane and expand it into a fishing rod and reel. Further, there is a long felt need in the art for a fishing pole walking cane combination device that offers a way for any physically limited individual to enjoy fishing. Finally, there is a long felt need in the art for a fishing pole walking cane combination device that comprises a rubber tip which is removed to allow the fishing pole to be extended.

The present invention, in one exemplary embodiment, is a novel fishing pole walking cane combination device. The device is a dual-purpose rod that can be used as both a walking cane and a fishing pole. The fishing pole walking cane combination device comprises a body component that is configured in a plurality of telescopic segments, that when collapsed, it is a walking cane and when extended, it will function as a fishing pole. The distal end of the body component comprises a curved cane handle and the proximal end of the body component comprises a rubber tip that can be taken off to allow the fishing pole to be extended. The body component also comprises a place for a reel to be secured and easily detached. The present invention also includes a novel method of converting a walking cane into a fishing pole. The method includes the steps of providing a fishing pole walking cane combination device comprising a body component configured in a plurality of telescoping segments, with a curved cane handle at the proximal end and a removable rubber tip at the distal end. The method also comprises collapsing the telescoping segments into the walking cane configuration and replacing the rubber tip. Further, the method comprises utilizing the walking cane to walk to a fishing spot. The method also comprises removing the rubber tip and expanding the telescoping segments into the fishing pole configuration. Finally, the method comprises utilizing the fishing pole to fish.

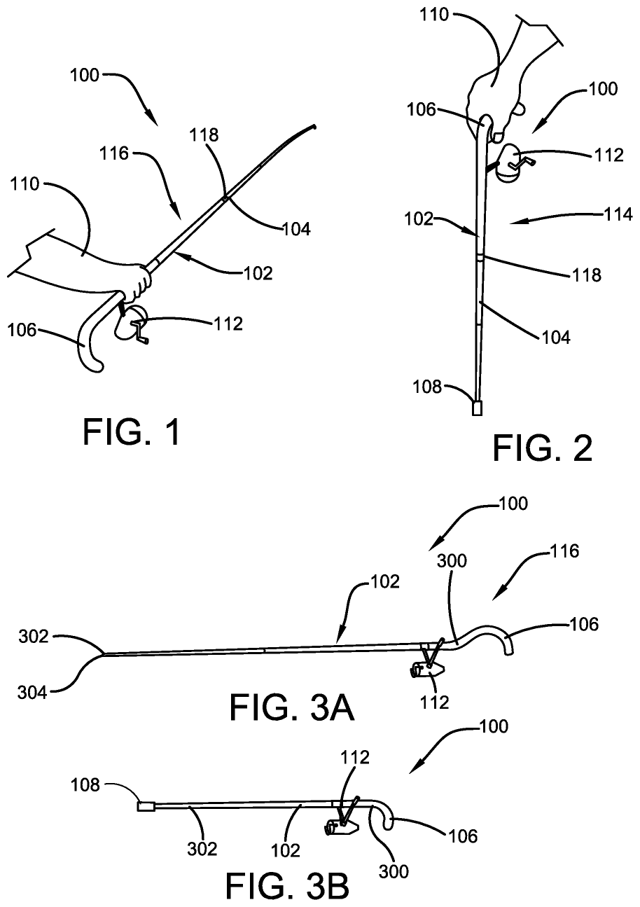

Referring initially to the drawings, FIGS. 1-2 illustrate a perspective view of one embodiment of the fishing pole walking cane combination device 100 of the present invention. In the present embodiment, the fishing pole walking cane combination device 100 is an improved fishing pole walking cane combination device 100 that provides a user 110 with a multifunctional, telescopic rod that doubles as a walking cane 114 and fishing pole 116. Specifically, the fishing pole walking cane combination device 100 comprises a body component 102 with a plurality of telescoping segments 104, that when collapsed are configured into a walking cane 114 and when extended, function as a fishing pole 116. At one end of the body component 102 is a handle component 106 and a removable rubber tip 108 is secured at the other end. The body component 102 also comprises a place for a fishing reel 112 to be secured and easily detached. Thus, users 110 can convert the body component 102 to a fishing pole 116 or walking cane 114 and vice-versa, making it much easier for physically limited users to travel to and from their favorite fishing locations with fishing equipment.

Generally, the fishing pole walking cane combination device 100 comprises a body component 102 that is configured in a plurality of telescopic segments 104, that when collapsed, it is a walking cane 114 and when extended, it will function as a fishing pole 116. Specifically, the body component 102 is configured in a cylindrical rod-like structure and configured into a single piece or multiple sections that telescope together. If multiple telescoping sections are used, the length of the body component 102 can be modified via a telescopic mechanism. Further, the body component 102 comprises at least one telescoping segment 104 that allows the total length of the body component 102 to be extended or retracted. Each telescoping segment 104 is hollow and has a slip lock 118 for locking the segment 104 at a specific length. Further, the slip lock 118 is released by means of pressing or turning the slip lock 118. The at least one telescoping segment 104 allows the body component 102 to have a length from approximately three feet to seven feet fully extended, allowing a user 110 to set the device 100 at a desired length. Thus, the device 100 is approximately three feet in length but can be adjusted to a length of approximately seven feet, if needed. Any type of telescoping locks, such as a clutch lock, cam lock, spring button, snap lock, set knob or any other suitable lock as is known in the art, can be used for securing a desired length of the telescoping segments 104 and for securing the telescoping segments 104 to each other, during extension and retraction of the telescoping segments 104 of the body component 102.

As shown in FIGS. 3A-B and 4A-C, the body component 102 comprises a proximal end 300 and a distal end 302. The distal end 302 of the body component 102 comprises a rubber tip or stopper 108 that can be taken off to allow the fishing pole 116 to be extended. Specifically, the distal end 302 of the body component 102 comprises the tip 304 of the fishing pole 116, when extended. The tip 304 of the fishing pole 116 is then covered with a rubber tip or stopper 108, to allow the device 100 to be used as a walking cane 114.

Furthermore, the proximal end 300 of the body component 102 comprises a handle component 106. Specifically, the handle component 106 extends outward from the opposing proximal end 300 of the body component 102 and may be secured to the proximal end 300 via any suitable securing means as is known in the art, such as heat-staked, adhesives, pinned, couplings, screws, snap fit, etc. In one embodiment, the body component 102 and the handle component 106 may be formed as a single, solid plastic assembly. The handle component 106 can be any suitable shape and size as is known in the art. Further, the length and diameter of the handle component 106 may vary widely, as it is important only that it be reasonably comfortable to hold in a user's hand with relative ease.

In one embodiment, the handle component 106 can also be curved or rounded, or otherwise ergonomically shaped to allow the user 110 to more easily use the device 100 as a walking cane 114. Specifically, the handle component 106 can be configured in a curved cane handle 306, a bent handle 308, or a straight handle 310 with a rubber knob end 312, etc., or any other suitable shape as is known in the art, depending on the wants and/or needs of a user 110. Further, the handle component 106 comprises a rubber coating 314 or other soft coating that provides gripping and texture for the user 110, during use.

Furthermore, the handle component 106 comprises a textured cross section or gripping area 316, or any other suitable ergonomic grip, texture, coating, etc., as is known in the art, depending on the needs and/or wants of a user 110.

In another embodiment, the handle component 106 may also be provided with an elongated hole 318 with a string or rope 320 attached, to allow the device 100 to be hung from a hook on a door or wall (not shown). Any other suitable securing means can be utilized as well, depending on the needs and/or wants of a user.

Additionally, the body component 102 comprises a fishing reel 112 secured thereto. Typically, the fishing reel 112 is secured to an inner section 322 near the handle component 106 at the proximal end 300, in any suitable manner as is known in the art, such as by a hook and a clamp device, screws, bolts, etc. The fishing reels 112 secured to the body component 102 are generally, a casing reel 324, a spinning reel 326, or a fly reel 328, however any other suitable fishing reel 112 can be secured to the body component 102 as is known in the art, depending on the needs and/or wants of a user 110.

Once the fishing reel 112 is attached to the body component 102, fishing line 330 is then threaded from the fishing reel 112 down the body component 102 via a plurality of eyelets 332, eyes, or tightly threaded rings and secured. In one embodiment, the device 100 can also comprise a plurality of rubber tip covers 334 for closing or capping the plurality of eyelets 332 during transport, to protect the fishing line 330.

Further, the body component 102 also comprises a rubber gripping component 336 or rubber coating that is applied around the circumference of the body component 102, past the handle component 106 and the fishing reel 112. The rubber gripping component 336 acts as a suitable ergonomic grip, texture, or coating for the body component 102, when the user 110 is using the fishing pole 116. Thus, when the body component 102 is configured as a fishing pole 116, the user 110 can use the rubber gripping component 336 as a handle, while casting and fishing with the device 100.

In one embodiment, the body component 102 comprises at least one compartment 338 for storing fishing accessories, such as fishing hooks, lures, bobbers, etc. The at least one compartment 338 would typically have a hinged lid 340 for securing the contents within. Any suitable number of compartments 338 can be utilized depending on the needs and/or wants of a user 110.

In use, to collapse the device 100, the slip locks 118 are disengaged from the telescoping segments 104 and the sections telescoped together. The user 110 then winds up the fishing line 330 within the fishing reel 112, as the fishing pole 116 is collapsed. After collapsing, the fishing reel 112 may be removed, as needed or locked into place for transport. A rubber stopper 108 or tip is applied to the distal end 302 of the body component 102 to cover and protect the tip 304 of the fishing pole 116, as well as to provide traction when using the walking cane 114. A user 110 can then grasp the handle component 106 and utilize the device 100 as a walking cane 114 to walk to their favorite fishing spot.

In use, to expand the device 100, the telescoping segments 104 are expanded to a desired height and slip locks 118 are engaged, securing the telescoping segments 104 at a desired length. Once secure, the user 110 then releases the fishing line 330 from the fishing reel 112 and threads it through the plurality of eyelets 332 to be secured at the distal end 302. The rubber cap 108 is then removed from the distal end 302, exposing the fishing pole tip 304. The user 110 can then grasp the rubber gripping component 336 as a handle to cast and fish with the fishing pole device 100.

Further, the fishing pole walking cane combination device 100 is made of a lightweight, durable material such as plastic, fiberglass, carbon fiber, or the like and manufactured through common extruding and molding processes. Generally, the fishing pole walking cane combination device 100 is also manufactured from a material that is water resistant or waterproof, or the body component 102 comprises a coating that is water resistant or waterproof. Furthermore, the fishing pole walking cane combination device 100 can be molded in various colors and patterns to be aesthetically pleasing, based on the wants and/or needs of a user 110.

In yet another embodiment, the fishing pole walking cane combination device 100 comprises a plurality of indicia 400. The body component 102 of the device 100 may include advertising, a trademark, or other letters, designs, or characters, printed, painted, stamped, or integrated into the body component 102, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be fishing pole, walking cane, or brand related.

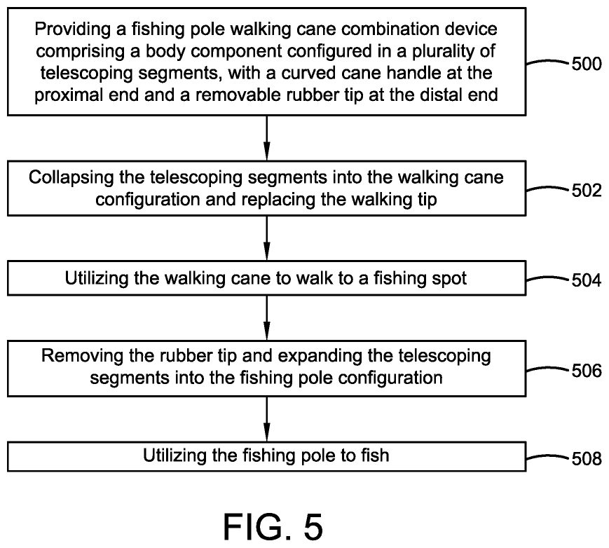

FIG. 5 illustrates a flowchart of the method of converting a walking cane into a fishing pole. The method includes the steps of at 500, providing a fishing pole walking cane combination device comprising a body component configured in a plurality of telescoping segments, with a curved cane handle at the proximal end and a removable rubber tip at the distal end. The method also comprises at 502, collapsing the telescoping segments into the walking cane configuration and replacing the rubber tip. Further, the method comprises at 504, utilizing the walking cane to walk to a fishing spot. The method also comprises at 506, removing the rubber tip and expanding the telescoping segments into the fishing pole configuration. Finally, the method comprises at 508, utilizing the fishing pole to fish.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “fishing pole walking cane combination device”, “fishing pole device”, “walking cane device”, and “device” are interchangeable and refer to the fishing pole walking cane combination device 100 of the present invention.

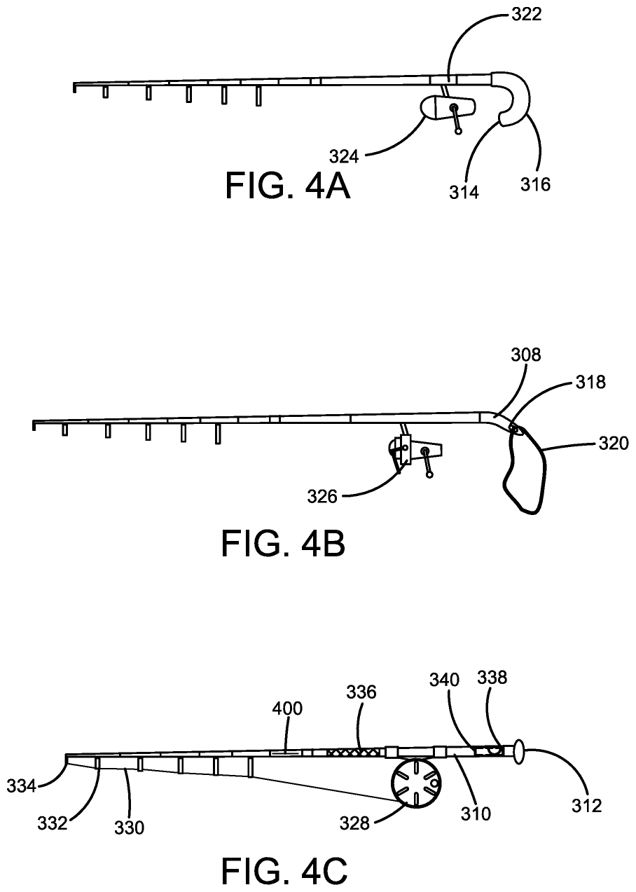

Notwithstanding the forgoing, the fishing pole walking cane combination device 100 of the present invention can be of any suitable size and configuration as is known in the art without affecting the overall concept of the invention, provided that it accomplishes the above stated objectives. One of ordinary skill in the art will appreciate that the fishing pole walking cane combination device 100 as shown in FIGS. 1-5 is for illustrative purposes only, and that many other sizes and shapes of the fishing pole walking cane combination device 100 are well within the scope of the present disclosure. Although the dimensions of the fishing pole walking cane combination device 100 are important design parameters for user convenience, the fishing pole walking cane combination device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fishing pole walking cane combination device that provides a user with a multifunctional, telescopic rod that doubles as a walking cane and fishing pole, the fishing pole walking cane combination device comprising:
a body component;
wherein the body component comprises a plurality of telescoping segments;
wherein an end of the body component comprises a handle component;
wherein an opposing end of the body component comprises a rubber stopper; and
further wherein the body component is expanded to function as a fishing pole and collapsed to function as a walking cane.

2. The fishing pole walking cane combination device of claim 1, wherein the body component is configured in a cylindrical rod-like structure and configured into a plurality of sections that telescope together.

3. The fishing pole walking cane combination device of claim 2, wherein a total length of the body component can be extended from approximately three feet in length to approximately seven feet.

4. The fishing pole walking cane combination device of claim 3, wherein each telescoping segment is hollow and has a slip lock for locking a telescoping segment at a specific length.

5. The fishing pole walking cane combination device of claim 4, wherein the body component comprises a proximal end and a distal end.

6. The fishing pole walking cane combination device of claim 5, wherein the distal end of the body component comprises the rubber stopper that can be taken off to allow the fishing pole to be extended.

7. The fishing pole walking cane combination device of claim 6, wherein the proximal end of the body component comprises the handle component.

8. The fishing pole walking cane combination device of claim 7, wherein the handle component is configured in a curved cane handle shape, a bent handle shape or a straight handle with a rubber knob end.

9. The fishing pole walking cane combination device of claim 8, wherein the handle component comprises a rubber coating that provides gripping and texture for the user.

10. The fishing pole walking cane combination device of claim 9, wherein the handle component comprises an elongated hole with a rope attached, to allow the device to be hung from a hook on a door or wall.

11. The fishing pole walking cane combination device of claim 10, wherein the body component comprises a fishing reel secured thereto.

12. The fishing pole walking cane combination device of claim 11, wherein the fishing reel can be a casing reel, a spinning reel, or a fly reel.

13. The fishing pole walking cane combination device of claim 12, wherein fishing line is threaded from the fishing reel down the body component via a plurality of eyelets.

14. The fishing pole walking cane combination device of claim 13 further comprising a plurality of rubber tip covers to cover the plurality of eyelets.

15. A fishing pole walking cane combination device that provides a user with a multifunctional, telescopic rod that doubles as a walking cane and fishing pole, the fishing pole walking cane combination device comprising:
a body component configured in a cylindrical rod-like structure and configured into a plurality of sections that telescope together;
wherein a total length of the body component can be extended from approximately three feet in length to approximately seven feet;
wherein each telescoping segment is hollow and has a slip lock for locking a telescoping segment at a specific length;
wherein a proximal end of the body component comprises a handle component;
wherein a distal end of the body component comprises a rubber stopper;
wherein the handle component is configured in a curved cane handle shape, a bent handle shape or a straight handle with a rubber knob end;
wherein the body component comprises a fishing reel secured thereto;
wherein the fishing reel can be a casing reel, a spinning reel, or a fly reel;
wherein fishing line is threaded from the fishing reel down the body component via a plurality of eyelets;
wherein to collapse the device, the slip locks are disengaged from the telescoping segments and the telescoping segments are telescoped together, and a rubber stopper is applied to the distal end of the body component to offer traction for walking cane; and
further wherein to expand the device, the telescoping segments are expanded to a desired length and the slip locks are engaged, securing the telescoping segments at the desired length, and the rubber stopper is removed, allowing a user to fish with fishing pole.

16. The fishing pole walking cane component of claim 15 further comprising a rubber gripping component applied around a circumference of the body component.

17. The fishing pole walking cane component of claim 15 further comprising at least one compartment with a hinged lid, for storing fishing accessories.

18. The fishing pole walking cane combination device of claim 15 further comprising a plurality of rubber tip covers to cover the plurality of eyelets.

19. The fishing pole walking cane combination device of claim 15 further comprising a plurality of indicia.

20. A method of converting a walking cane into a fishing pole, the method comprising the following steps:
providing a fishing pole walking cane combination device comprising a body component configured in a plurality of telescoping segments, with a curved cane handle at the proximal end and a removable rubber tip at the distal end;
collapsing the telescoping segments into the walking cane configuration and replacing the rubber tip;
utilizing the walking cane to walk to a fishing spot;
removing the rubber tip and expanding the telescoping segments into the fishing pole configuration; and
utilizing the fishing pole to fish.
